(19) United States
(12) Patent Application Publication
(10) Pub. No.: US 2008/0172693 A1
(43) Pub. Date: Jul. 17, 2008

(54) Representing Television Programs Using Video Objects

(75) Inventor: Edward A. Ludvig, Redwood City, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/623,599

(22) Filed: Jan. 16, 2007

(51) Int. Cl. G06F 3/00

(52) U.S. Cl. 725/40; 725/43

(57) ABSTRACT

A video class is a programmatic interface and an abstraction of a receivable audio/video/data feed. A video object can be instantiated and thereafter referenced by computer applications running on the receiving device. The video object properties characterize the video object content source, and the presentation of the content on the display device. The video object includes methods to control the properties of the video object.

### BACKGROUND

For many years televisions were able to display only a single program at a time. More recently, techniques have been developed to allow multiple resized programs to be concurrently displayed on a single television.

Although displaying multiple programs concurrently on a single television may be welcomed by many users, such displaying can also cause problems. For example, there may be a problem with regard to identifying which of the multiple programs is to have its audio played back. By way of another example, it may be desirable to display additional data associated with the program to the user of the television along with the program (e.g., if the program is a baseball game, it may be desirable to display statistics regarding the current batter). If two baseball games are being displayed concurrently, the problem arises as to which of the two baseball games should have its additional data displayed, and a further problem arises as to where that data should be displayed. Thus, it would be beneficial to have a way to resolve these problems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with certain aspects of representing television programs using video objects, a plurality of television programs are displayed simultaneously on a display. Each of the plurality of television programs has associated with it a video object to facilitate the identification of these television programs. For each television program, a program identifier and an enhanced data identifier of enhanced data for the television program can be identified based on the video object corresponding to the television program. The program identifier and the enhanced data identifier can also be used to obtain the enhanced data for the television program.

In accordance with certain aspects of the representing television programs using video objects, a video object corresponding to a television program includes both properties of the corresponding television program and methods that can be invoked. The properties include the location on a display where the television program is displayed (e.g., its size and position), the source of the television program (e.g., the television channel of the television program), and identifiers (e.g., packet identifiers (PIDs)) for the video, audio, and data components of the television program. The methods include a private data filter method that allows an application to turn on or off the acquisition of private data from the television program associated with the video object, and an audio control method that allows an application to enable or disable presentation of one of the audio components of the television program associated with the video object.

### BRIEF DESCRIPTION OF THE DRAWINGS

The same numbers are used throughout the drawings to reference like features.

FIG. 1 is a block diagram illustrating an example client device in which the representing television programs using video objects can be implemented.

FIG. 2A illustrates an example display having multiple different display portions.

FIG. 2B illustrates an example of the display of FIG. 2A having a user interface generated from enhanced data.

FIG. 3A illustrates another example display having multiple different display portions.

FIG. 3B illustrates an example of the display of FIG. 3A having a user interface generated from enhanced data.

FIG. 4 illustrates an example system including multiple television programs.

FIG. 5 illustrates an example video object.

FIG. 6 is a flowchart illustrating an example process for representing television programs using video objects.

FIG. 7 is a flowchart illustrating an example process for displaying enhanced data of a television program.

FIG. 8 illustrates an example IP-based television (IPTV) environment in which embodiments of the representing television programs using video objects can be implemented.

FIG. 9 illustrates various components of an example client device in which embodiments of the representing television programs using video objects can be implemented.

FIG. 10 illustrates an example entertainment and information system in which embodiments of the representing television programs using video objects can be implemented.

### DETAILED DESCRIPTION

Representing television programs using video objects is discussed herein. A television display is separated into two or more different portions, with a different television program being displayed in each portion. A video object is associated with each of these television programs. The video object describes the location of the portion on the television display in which the associated television program is displayed, an identifier of the source of the associated television program, and identifiers of the different components (e.g., video, audio, data, etc.) of the associated television program. Various methods for controlling the presentation of the components of the television program are also included in the video object, such as methods for turning the audio of the program on and off, turning the video of the program on and off, turning private data filtering for the program on an off, changing one or more of the properties of the video object, and so forth. A private data filter can be invoked to extract the data component from the associated television program data to allow a user interface and interaction model based on that extracted data to be displayed to the user along with the television program. One or more of the television programs can be selected to have such user interfaces displayed, and the application executing the acquired data can display resulting user interfaces and information while considering the video object's position by referencing the video object's position properties.

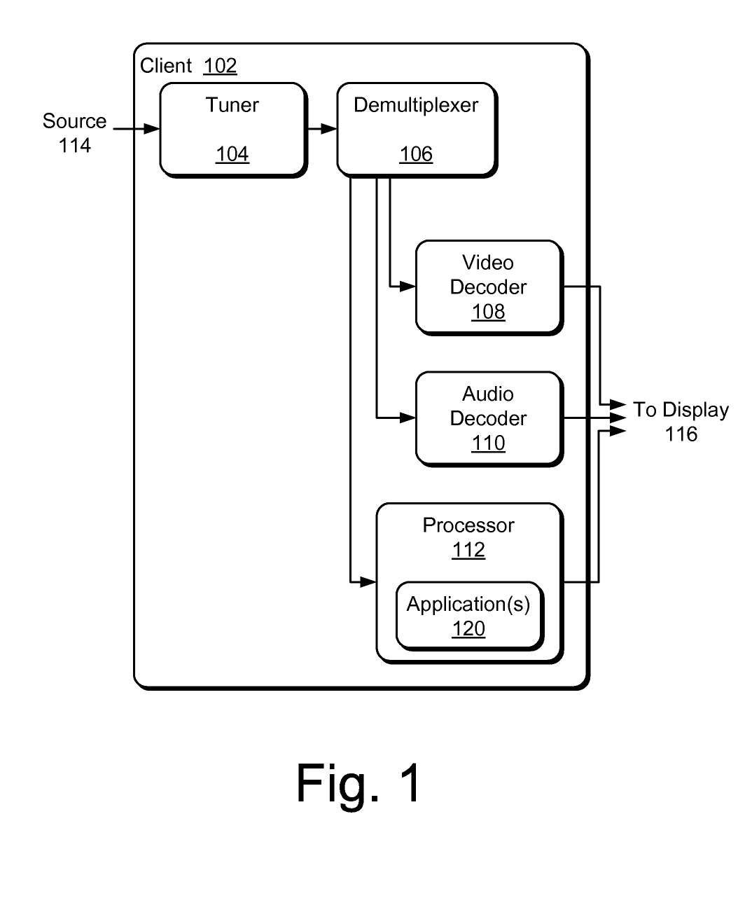

FIG. 1 is a block diagram illustrating an example client device in which the representing television programs using video objects can be implemented. A client device 102 includes a tuner 104, a demultiplexer (demux) 106, a video decoder 108, an audio decoder 110, and a processor 112. Client device 102 can be a standalone device (e.g., a set-top box), or alternatively may be incorporated into a television.

Source television programming 114 is received by tuner 104. Source television programming 114 can be received in any of a variety of manners, such as radio frequency (RF) signals, digital or analog signals over cable or from a satellite, digital or analog signals from a digital video recorder (DVR), data packets from a computer network (such as the Internet), and so forth. The data signals received by client device 102, whether they are digital signals, network packets, or some other signals, are referred to as the transport stream. Oftentimes digital sources are encapsulated in Moving Picture Experts Group (MPEG) transport streams, which may be conveyed over quadrature amplitude modulation (QAM) or over Internet Protocol (IP) packets, may originate from a DVR, and so forth. Analog data signals can be received in different manners, such as within the vertical blanking interval (VBI).

A client application selects a particular source by way of tuner 104 or by playing content from a DVR. This selection is performed by instantiating a video object. Instantiation of a video object includes defining the initial state of the video object properties, including the source and the position of the video object display. Tuner 104 tunes to the selected source. Tuner 104 can tune to a particular transport stream and/or channel in any of a variety of conventional manners depending on the manner in which source television programming 114 is received. Typically, tuner 104 can tune to only one channel at a time.

Client device 102 acquires a source as dictated in the properties of the instantiated video object. In the case of a digital source, the particular transport stream encapsulating the channel tuned to by tuner 104 is input to demultiplexer 106. A particular transport stream may include multiple channels, in which case demultiplexer 106 extracts (or tunes to) a particular one of those multiple channels. Demultiplexer 106 extracts a particular channel so that the television program(s) being transmitted on that channel can be processed by client 102. Demultiplexer 106 can extract a particular channel(s) in any of a variety of different conventional manners based on the way in which source television programming 114 is received.

Multiple different components are typically included for the television program being transmitted on a channel, such as an audio component(s), a video component(s), enhanced data component(s), and so forth. Demultiplexer 106 extracts the different components for the television program as dictated by the video object associated with the television program, and transmits the video component to video decoder 108, the audio component to audio decoder 110, and the enhanced data component to processor 112. Demultiplexer 106 can operate in any of a variety of different conventional manners to extract the different components based on the manner in which the components are embedded in the received source television programming 114.

In certain embodiments, a particular channel may include multiple video component(s) and/or multiple audio component(s) for the same television program. For example, a particular program may include different camera views as different video component(s), and/or may include different language versions of the television program as different audio component(s). However, for ease of explanation, the techniques discussed herein will be described primarily as if only a single video component is included. Demultiplexer 106 can be configured (e.g., by a user of client device 102) to select a particular one of multiple video components to be transmitted to video decoder 108, and a particular one of multiple audio components to be transmitted to audio decoder 110.

Video decoder 108 decodes the video component of the program in any of a variety of different conventional manners based on the manner in which the video component was encoded prior to being transmitted to client device 102. The decoded video component is then transmitted to display device 116 for display to the user. Audio decoder 110 decodes the audio component of the program in any of a variety of different conventional manners based on the manner in which the audio component was encoded prior to being transmitted to client device 102. The decoded audio component is then transmitted to display device 116 (or alternatively a separate speaker(s)) for playback to the user.

Processor 112 receives the enhanced data component of the television program from demultiplexer 106 and processes the received data. The enhanced data can take any of a variety of different forms, such as private data for Moving Picture Experts Group (MPEG) television programs, DigiCipher II (DC2) text messages used for television programs by some devices from Motorola, Inc., IP datagrams, any of a variety of other data encapsulation formats, and so forth.

One or more applications 120 can be run by processor 112 to process enhanced data for different programs, and the appropriate application for the television program on the particular channel that is tuned to is executed, if not already running, to process the received enhanced data. The enhanced data is typically processed to generate, on display device 116, a user interface (UI) associated with the television program being displayed. Alternatively, the enhanced data may also be processed to perform other operations and/or actions that do not involve displaying a UI.

Processing of the received enhanced data can take different forms. For example, processor 112 may simply display, as the user interface, the received data. By way of another example, the received data may describe how processor 112 is to display particular graphics and/or text for the user interface. Processor 112 then transmits the processed enhanced data to display device 116 for presentation to the user. By way of yet another example, the received data may describe an entire user interaction model, including a user interface that is to present data to the user and also accept input from the user (e.g., text input, arrow key and select key events for the purpose of navigating and selecting in the user interface, and so forth), how input from the user is to be processed and what results are to be returned to the user, and so forth. Typically processor 112 generates text, graphics, or other visual items to be displayed to the user. Alternatively, processor 112 may generate audio to be played back to the user.

Client device 102 is discussed primarily with reference to receiving enhanced data for a television program on the same channel as the video and audio components of the television program are received. Alternatively, the enhanced data for a television program can be received in different manners. For example, the enhanced data may be received on a separate channel from source 114. By way of another example, the enhanced data may be received on other media, such as on a disc, as a file or packets over a network (such as the Internet), and so forth.

In order to avoid cluttering the drawings, client device 102 has been illustrated with a single tuner 104, a single demultiplexer 106, a single video decoder 108, a single audio decoder 110, and a single processor 112. Alternatively, client device 102 may include multiple tuners 104, multiple demultiplexers 106, multiple video decoders 108, multiple audio decoders 110, and/or multiple processors 112. In certain embodiments, tuner 104 can tune to multiple different channels concurrently. Alternatively, multiple tuners 104 may be included in client device 102, each being able to tune to a different channel.

In certain embodiments, an application 120 being executed by processor 112 allows and controls the display of multiple different television programs displayed on display device 116 concurrently using multiple tuners 104. These different television programs are displayed in different portions or windows of the display device. These different portions or windows can be the same or different sizes. The display can be separated into any number of different portions. The generation and display of different windows or portions for different television programs (such as picture in picture (PIP)) can be performed in any of a variety of conventional manners.

The application 120 that controls the display of multiple television programs concurrently can be the same application that processes the enhanced data for the television programs, or alternatively can be a different application. The television programs that are received as source television programming 114 are tuned to by tuners 104 and demultiplexer 106, and each of the programs is re-sized to the portion or window in which it will be presented. This re-sizing is typically performed by a scaling application 120 being executed by processor 112, which may be the same application as processes the enhanced data, the same application as controls the display of multiple television programs concurrently, and/or may be a different application. Alternatively, another component other than processor 112 may perform this re-sizing.

Typically, a single one of the multiple television programs is selected (e.g., by the user or by default) to have its audio played back. Alternatively, the audio from multiple (or all) of the television programs may be played back concurrently in certain situations.

A user interface generated from enhanced data can be displayed to the user as an overlay superimposed on a portion of the display. Alternatively, enhanced data can be displayed to the user in a “blank” space next to one of the portions. Regardless of whether the data is displayed as an overlay on a portion or in blank space next to a portion, it is beneficial to know the locations of the different portions of the display so that the data for a portion can be displayed in a location that does not interfere with, or interferes little with, the other portions. The location of the user interface generated from the enhanced data is determined by application 120 based at least in part on the locations of the different portions of the display being used to display programs.

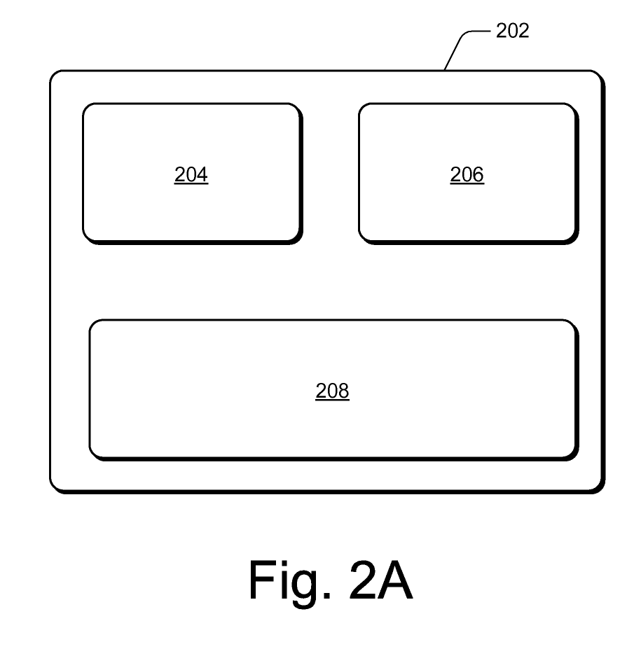

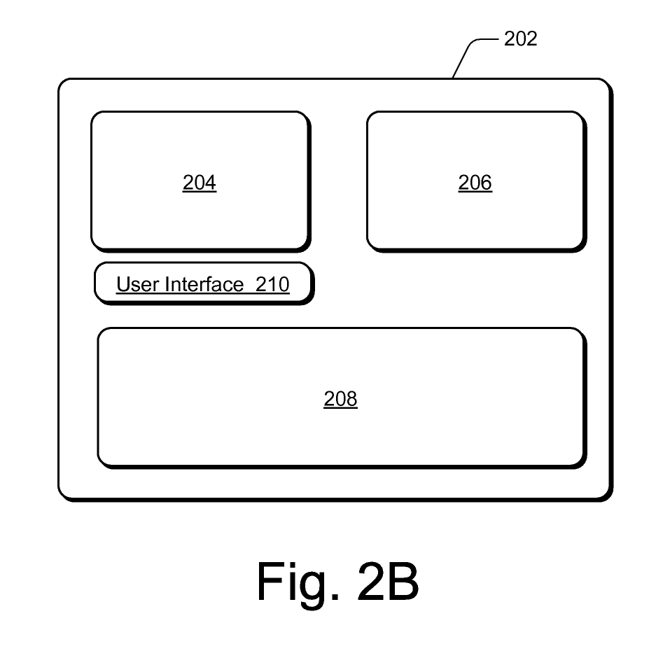

FIG. 2A illustrates an example display 202 having three different display portions: portion 204, portion 206, and portion 208. A different television program is displayed in each of these different portions 204, 206, and 208. Alternatively, two or more portions 204, 206, and 208 may display the same program (e.g., multiple views of the same program). As illustrated in FIG. 2A, there can be some “blank” space on display 202 in which no television program is displayed.

FIG. 2B illustrates an example of display 202 having a user interface 210 generated from enhanced data for the television program displayed in portion 204. As illustrated in FIG. 2B, user interface 210 is displayed in the “blank” space below portion 204.

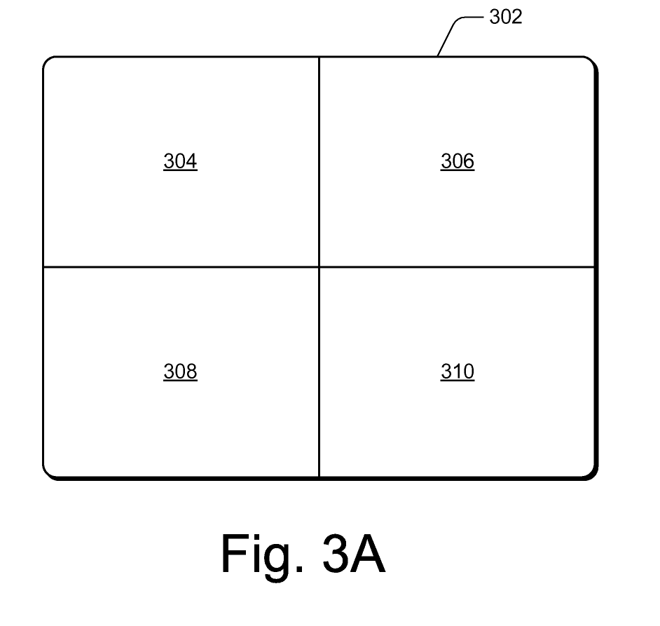

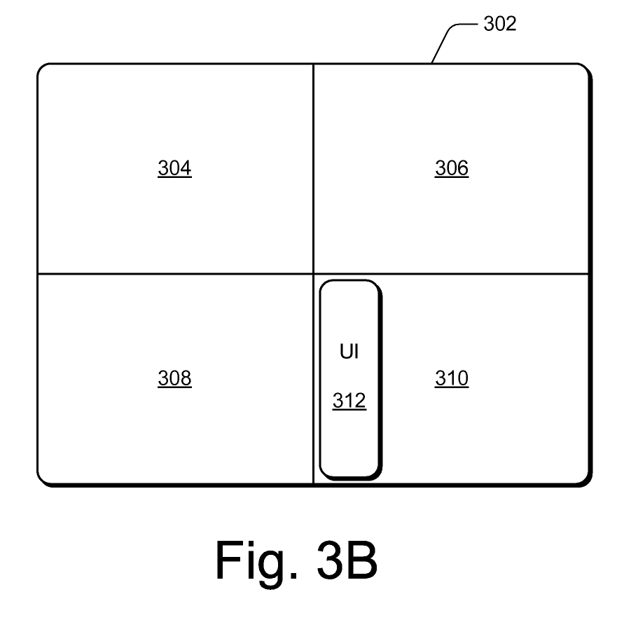

FIG. 3A illustrates another example display 302 having four different display portions: portion 304, portion 306, portion 308, and portion 310. A different television program is displayed in each of these different portions 304, 306, 308, and 310. Alternatively, two or more portions 304, 306, 308, and 310 may display the same program. Unlike display 202 of FIG. 2A, there is no blank space visible on display 302—the entire display 302 is used to display television programs.

FIG. 3B illustrates an example of display 302 having a user interface 312 generated from enhanced data for the television program displayed in portion 310. As illustrated in FIG. 3B, user interface 312 is displayed superimposed on portion 310.

A different video object is associated with each of the programs displayed within a portion of the display (e.g., each portion as illustrated in FIGS. 2A-3B). In certain embodiments, an application 120 allows the user to select a particular portion of the display, such as by selection from a pull-down menu, entry of a program or portion identifier on a remote control device, using a cursor control device to move a cursor over a particular portion being displayed, using a cursor control device or other control device to scroll through different portions (e.g., having a border around a particular portion highlighted when that portion is selected), and so forth. This selection of a particular portion allows the data for the selected portion to be presented to the user. For example, for the selected portion, the audio for the program displayed in that portion is turned on (while the audio for the programs displayed in the other portions is turned off), the video for the program displayed in that portion is turned on (while the video for the programs displayed in the other portions may be turned on or off), and the enhanced data for the program displayed in that portion is turned on (while the enhanced data for the programs displayed in the other portions is turned off, moved, or otherwise altered so as not to interfere with the presentation of the enhanced data for the program).

When displaying a user interface generated from enhanced data for a television program, an application 120 of FIG. 1 uses the locations of the various portions being displayed (e.g., as illustrated in FIGS. 2A-3B) to intelligently determine the location of the user interface. The user interface can be located in a blank space between portions (e.g., as illustrated in FIG. 2B), or overlay a portion (e.g., as illustrated in FIG. 3B). The locations of the blank spaces are known because application 120 knows the locations of the portions in which television programs are being displayed. The location of the user interface generated by the application 120 can take any of a variety of forms, such as: a box below, to the side of, or overlaying the portion; an area wrapping around two or more sides of the portion; an area partially overlaying a portion(s) and partially in a blank space next to the portion; and so forth.

It should also be noted that multiple user interfaces for the enhanced data for multiple television programs may optionally be displayed by an application 120 concurrently. In such situations, application 120 takes care to display the user interfaces so that they do not interfere with, or interfere little with, each other. For example, the user interface generated from enhanced data for a first television program may be displayed in a blank space between portions, while the user interface generated from enhanced data for a second television program may be displayed overlaying a portion. By way of another example, the user interfaces generated from the enhanced data for two or more television programs may be displayed in the blank spaces between portions. By way of yet another example, the user interface(s) generated from the enhanced data for one or more television programs may be displayed overlaying the corresponding portion (the portion in which the corresponding television program is being displayed). By way of still another example, the user interface may always be displayed in the same area of the display, but only one of the television programs is selected to have its user interface displayed at any one time. Regardless of where the user interface(s) is displayed, having knowledge of the placement of the different portions on the display facilitates the placement of the user interface for data corresponding to any or all of the portions.

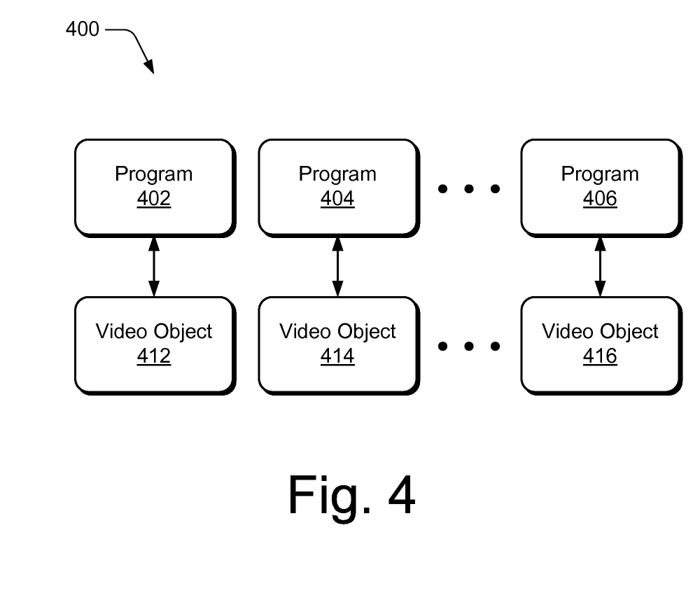

FIG. 4 illustrates an example system 400 including multiple television programs 402, 404, . . . , 406. System 400 can be, for example, the television programs displayed by a client 102 of FIG. 1 as one of displays 202 of FIG. 2A or 2B, or 302 of FIG. 3A or 3B. Each television program 402, 404, . . . , 406 has an associated or corresponding video object 412, 414, . . . , and 416, respectively. Video objects 412, 414, . . . , and 416 are instantiated or created by an application 120 of FIG. 1.

Each video object 412, 414, . . . , 416 describes a portion of a display in which the television program corresponding to the video object is being displayed. Various properties of the portion of the display and the corresponding television program can be included in video objects 412, 414, . . . , 416, such as the location of the portion on the display, information describing the program being displayed (e.g., call letters of the channel on which the program is being transmitted, a number of the channel on which the program is being transmitted, a source of the channel on which the program is being transmitted or from which it is being read (e.g., a DVR) or streamed, and so forth), identifiers of the video, audio, and data components of the program, and so forth. Each video object 412, 414, . . . , 416 can also include one or more methods (e.g., application programming interface (APIs)) for controlling the presentation of the components of the program, such as a method(s) for turning on and off audio playback for the program, a method(s) for turning on and off video display for the program, a method(s) for turning on and off a private data section filter for the program, a method(s) for changing the location and/or size properties of the video object, and so forth.

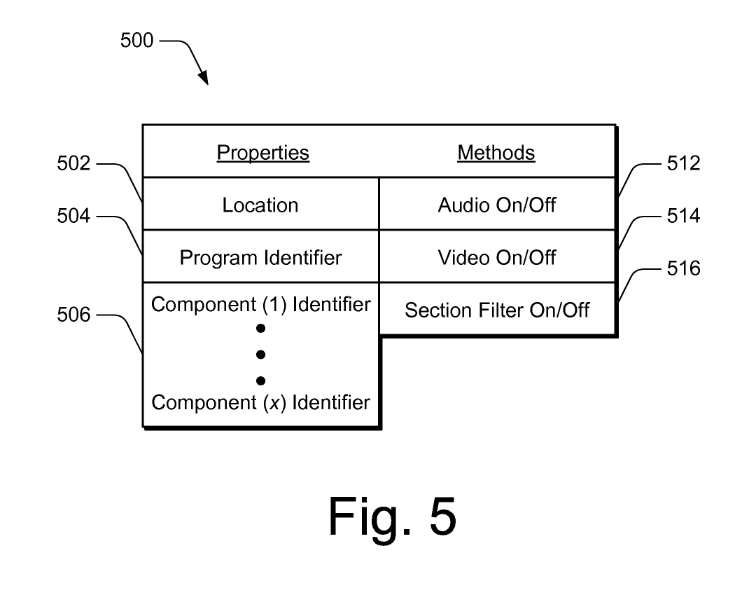

FIG. 5 illustrates an example video object 500. Video object 500 is an example of a video object 412, 414, . . . , 416 of FIG. 4. Each portion of the display in which a television program is being displayed has a corresponding video object 500. Video object 500 includes a location field or property 502, a program identifier field or property 504, and a component identifier field or property 506. Video object 500 is instantiated by a client application (e.g., application 120 of FIG. 1) from a video class that is a programmatic interface and an abstraction of a receivable audio/video/data feed.

Location field 502 includes an identification of the location of the portion on the display device. The locations of the various portions of the display can be identified in any of a variety of different manners and using any of a variety of different coordinate systems. The locations are, for example, coordinates of the display device where the portion is situated. For example, the display can be viewed using an X,Y coordinate system, and the location of the portion on the display can be identified using two opposite corners (or alternatively three or four corners) of the rectangular portion. Alternatively, other coordinate systems or other techniques can be used to identify the locations of the portions, and portions may be different shapes other than rectangles (e.g., portions may be ovals, circles, any polygon, and so forth).

Program identifier field 504 includes a unique identifier of the television program being displayed in the portion. As the same program can be transmitted to different client devices in different manners (e.g., on different channels, on different television networks, by cable or satellite, and so forth), a unique identifier is assigned to each program so that the program can be identified regardless of the manner in which it is transmitted to the client devices. These unique identifiers may also be assigned by the guide listings provider, such as TVG or Tribune Media Services. This unique identifier is typically assigned by the author or creator of the television program (e.g., the party responsible for making the television program available for distribution), although alternatively it may be assigned by another party. The program identifier may also be referred to as a source identifier for television programs received via cable, and may also be referred to as a media descriptor for television programs received via the Internet (e.g., as IPTV, as discussed in more detail below) or originating from a DVR or another media source. The program identifier can include various information, such as the call letters of the source of the program, the channel number used by that source, an identification of the source (e.g., the television network), and so forth.

The program identifier can be embedded in the transport stream or channel along with the components of the television program, can be obtained from a television programming guide (e.g., an electronic programming guide), and so forth. Client device 102 can obtain this unique identifier from the transport stream or channel or programming guide and populate program identifier field 504 with the obtained identifier for the tuned to television program.

Component identifier field 506 includes multiple (x) identifiers of the components of the corresponding television program. As discussed above, each television program can have multiple different components, such as a video component, one or more audio components, an enhanced data component, and so forth. A different identifier is included in component identifier field 506 for each of these different components. Alternatively, multiple fields 506 may be included in video object 500 and each field 506 may include an identifier of a different component of the corresponding television program. In certain embodiments, each component identifier is a packet identifier (PID), although in alternate embodiments other identifiers are used.

When a television program has corresponding enhanced data, field 506 includes a data component identifier and a descriptor tag for the enhanced data. While component identifiers may change as a result of remultiplexing operations, descriptor tags should arrive at the client device unchanged. Typically, enhanced data to be processed by different application programs are assigned different component identifiers, and all enhanced data (across all programs) that is to be processed by the same application program is typically assigned the same descriptor tag(s). For example, there may be multiple different baseball games that the user can tune to at any one time, and each of these different baseball games may have its own enhanced data, but all of this enhanced data is to be processed by a baseball application 120 being executed by processor 112 of FIG. 1, so all of this enhanced data for all of the baseball programs would have the same particular descriptor tag(s). Following this example, whenever the baseball application 120 identifies a program with enhanced data having one of these particular descriptor tag(s), the baseball application 120 knows that it is to process the corresponding enhanced data. Alternatively, the component identifier may be used rather than the descriptor tag, although care should be taken to ensure that different sources use the same component identifiers.

Additionally, in certain situations the enhanced data may encapsulate an explicit application identifier. This application identifier identifies a particular application 120 that is to be executed by processor 112 in order to process the enhanced data. Another application, such as a monitor application, being executed by processor 112 can detect such application identifiers encapsulated in the enhanced data and launch the identified application when detected.

Furthermore, enhanced data may be proprietary in which case a specific corresponding application would be called to execute the data. Enhanced data may also be standard in which case any application compliant with the standard may execute the data, however care may need to be taken, unless intentional, so that multiple applications do not attempt to execute the enhanced data simultaneously (for example, so that two or more applications do not unintentionally attempt to render conflicting user interfaces from the same enhanced data). Typically, enhanced data should encapsulate an application identifier specifying which application should run the enhanced data. Typically, the enhanced data component descriptor tag allows the client (which could be a monitor application) to identify if there is enhanced data. The descriptor tag may be sufficient to identify the target application to execute the data, especially in the cases where the data is proprietary. Relying on an explicit application identifier, however, allows exactly which of multiple compatible applications is the intended recipient of the data to be specified.

Each field 506 may also include additional information describing the component (e.g., a stream type identifier indicating whether it is a video component, an audio component, or an enhanced data component; indicating what language the component is in; and so forth). Alternatively, some or all of this information may be inherent in the particular field. For example, rather than a single field 506, multiple fields 506 may be included in video object 500, one or more of the multiple fields being used only for video components and one or more of the multiple fields being used only for audio components. Thus, in this alternative example, the type of component can be readily identified based on the particular field the identifier is included in.

Video object 500 also includes an audio on/off method 512, a video on/off method 514, and a private data filter on/off method 516. The methods of video object 500 allow the properties of video object 500 to be controlled and allow the presentation of the components of the television program corresponding to video object 500 to be controlled. Audio on/off method 512 can be invoked by an application 120 of FIG. 1 to turn the audio for the program corresponding to object 500 on and off. When turned on, the audio for the corresponding program is played back, and when turned off, the audio for the corresponding program is not played back (or is muted). Audio can be turned off for a program in a variety of different manners, such as demultiplexer 106 of FIG. 1 not passing the audio data for the program to audio decoder 110, audio decoder 110 not passing the audio data to the display (or other speakers) for playback, an application 120 muting the program, and so forth.

The application 120 includes, as parameters when invoking method 512, the component identifier of the particular audio component of the corresponding program that is to be turned on or off, as well as an indication of whether the audio is to be turned on or off. Alternatively, if the corresponding program has only one audio component, then the component identifier need not be specified. Additionally, although a single method 512 for turning the audio on and off is illustrated, alternatively two different methods may be employed: one that is invoked to turn the audio on, and another that is invoked to turn the audio off.

Video on/off method 514 can be invoked by an application 120 of FIG. 1 to turn the video display for the program corresponding to object 500 on and off. When turned on, the video for the corresponding program is displayed, and when turned off, the video for the corresponding program is not displayed. Video can be turned off for a program in a variety of different manners, such as demultiplexer 106 of FIG. 1 not passing the video data for the program to video decoder 108, video decoder 180 not passing the video data to the display, an application 120 preventing the video data from being passed to the display, and so forth.

The application 120 includes, as parameters when invoking method 514, the component identifier of the particular video component of the corresponding program that is to be turned on or off, as well as an indication of whether the video is to be turned on or off. Alternatively, if the corresponding program has only one video component, then the component identifier need not be specified. Additionally, although a single method 514 for turning the display of the video on and off is illustrated, alternatively two different methods may be employed: one that is invoked to turn the video on, and another that is invoked to turn the video off.

Private data filter on/off method 516 can be invoked by an application 120 of FIG. 1 to turn the private data filtering for the program corresponding to object 500 on and off. When the private data filtering is turned on, a section filter is enabled to obtain the enhanced data (the private data) for the program corresponding to object 500. The program identifier included in field 504 and the enhanced data identifier included in field 506 are both passed to the private data filter to identify the particular enhanced data to be obtained (in certain embodiments, the entire video object 500 is passed to the private data filter). The private data filter operates in a conventional manner to obtain the enhanced data for the program identified in the parameters passed to it, and passes the obtained enhanced data to the application 120 processing the enhanced data (typically the same application that invoked object 500). The application 120 is then able to process the enhanced data and present an appropriate user interface based on the enhanced data.

When the private data filtering is turned off, the application 120 no longer presents newly received enhanced data via the user interface indicated by the enhanced data. The private data filter may no longer obtain the enhanced data, the private data filter may no longer pass the enhanced data to the application 120, or the application may ignore the enhanced data passed to it by the private data filter. The application 120 may continue to present the user interface indicated by the enhanced data when the private data filtering is turned off, but does not obtain data updates. Alternatively, the application 120 may stop presenting the user interface when the private data filtering is turned off. Typically, the application 120 exits (stops executing) when the private data filtering is turned off.

The application 120, as parameters when invoking method 516, includes the component identifier of the particular enhanced data component of the corresponding program that is to be turned on or off, as well as an indication of whether the enhanced data is to be turned on or off. Alternatively, if the corresponding program has only one enhanced data component, then the component identifier need not be specified. Additionally, although a single method 516 for turning the section filter on and off is illustrated, alternatively two different methods may be employed: one that is invoked to turn the private data filter on, and another that is invoked to turn the private data filter off.

Additional methods may also optionally be included in video object 500. For example, one or more methods for changing one or more properties of video object 500 may be included in video object 500, such as a method for changing the location of the display in which the corresponding television program is being displayed, a method for changing which components 506 are presented to the user, and so forth.

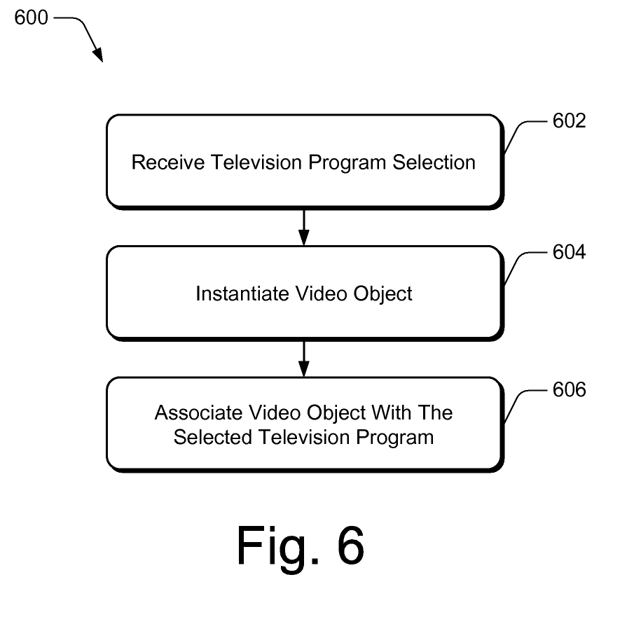

FIG. 6 is a flowchart illustrating an example process 600 for representing television programs using video objects. Process 600 can be implemented in software, firmware, hardware, or combinations thereof. In certain embodiments, process 600 is carried out by one or more applications running 120 on processor 112 of FIG. 1.

A selection of a television program is initially received (act 602). This selection can be performed in any of a variety of manners, such as selection of a particular television channel, selection of a particular television program from an electronic programming guide, selection of a particular television program stored on a DVR, and so forth. Once selected, a video object is instantiated (act 604) and associated with the selected television program (act 606). This video object is, for example, a video object 500 of FIG. 5. Once instantiated, the video object can be referenced by computer applications running on the client device. As discussed above, the video object properties characterize the video object content source and the presentation of the content on the display device, and the video object methods control the properties of the video object.

Returning to FIG. 4, video objects 412, 414, . . . , 416 can be used to facilitate displaying of programs 402, 404, . . . , 406. For example, video objects 412, 414, . . . , 416 can be used to turn on and off the audio and/or the video for the corresponding programs 402, 404, . . . , 406. By way of another example, video objects 412, 414, . . . , 416 can be used when displaying an additional program (e.g., the location on the display of the additional program can depend at least in part on the locations of other programs already being displayed, other programs already being displayed may have their locations on the display modified to accommodate the display of the additional program, and so forth). By way of yet another example, video objects 412, 414, . . . , 416 can be used to facilitate the display of enhanced data for one or more of programs 402, 404, . . . , 406 (e.g., the location of the enhanced data can be determined based on the locations of the programs 402, 404, . . . , 406, as discussed above with respect to FIGS. 2A-3B).

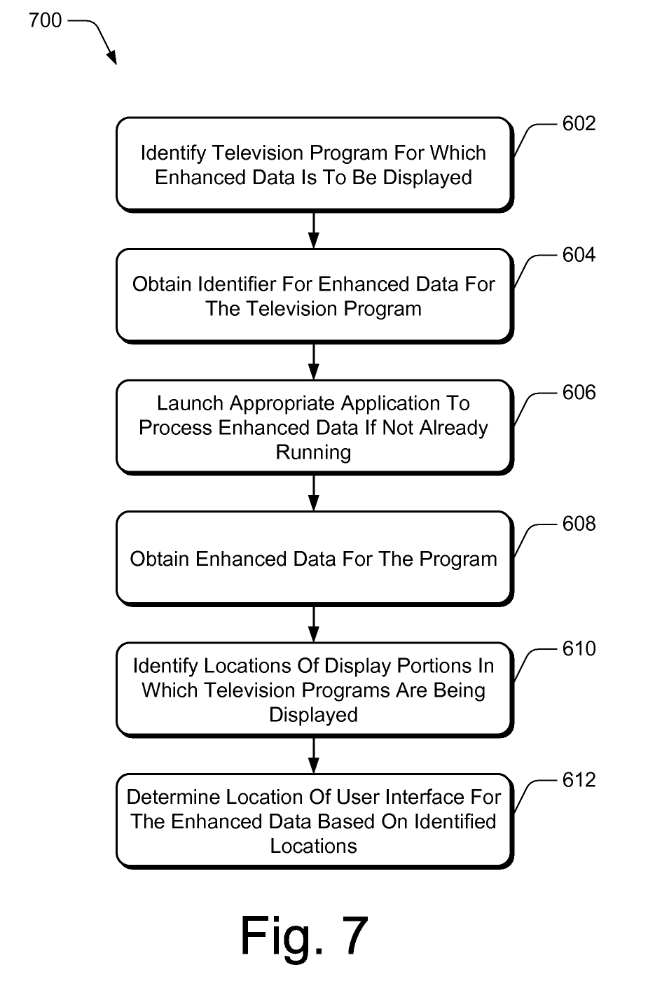

FIG. 7 is a flowchart illustrating an example process 700 for displaying enhanced data of a television program. Process 700 can be implemented in software, firmware, hardware, or combinations thereof. In certain embodiments, process 700 is carried out by one or more applications running 120 on processor 112 of FIG. 1.

Initially, a television program for which enhanced data is to be displayed is identified (act 702). When multiple television programs are displayed concurrently, one of the multiple programs is selected to have its enhanced data displayed. This program can be selected in different manners. The user may select the program, such as by using a remote control device, cursor control device, input keys on a set top box, and so forth. For example, an on-display user interface may allow the user to select one of the multiple programs, such as a menu that lists all of the programs (e.g., the user can scroll through the menu using a cursor control device or keys on a remote control device, and then press an “enter” or “select” button when the desired program is highlighted to select the desired program), or may allow a border around a portion to be highlighted so that the user can select that portion (e.g., the user can use a cursor control device or keys on a remote control device to highlight a particular border, and then press an “enter” or “select” button to select that portion, or leaving a particular portion highlighted for greater than a threshold amount of time may cause that particular portion to be selected, etc.), and so forth. Alternatively, an initial default selection may be automatically made (and optionally overridden later by the user). For example, the portion in which the most recent channel change was made may be automatically selected, if the audio of only one portion is played back at a time then the portion having its audio played back may be automatically selected, and so forth.

Additionally, in certain embodiments a check is made as to which of the multiple television programs have enhanced data. When the user is allowed to scroll through programs or highlight portions in act 702, only those television programs having enhanced data are made available for selection. This prevents, for example, a user from selecting a television program in order to have its enhanced data displayed, only to discover that there is no enhanced data for that television program.

An identifier of the enhanced data for the television program is obtained (act 704). This identifier allows the enhanced data to be retrieved from a source. The identifier can be obtained in different manners. In certain implementations, this identifier is referred to as a packet identifier (PID), although other identifiers may alternatively be used.

In certain embodiments, the identifier of the enhanced data for a television program is embedded in a table or other structure along with the identifier of the audio and video components of the program, and the identifier is obtained from this table or other structure. In other embodiments, the identifier may be retrieved from some known location (e.g., a location in memory or in a network), the identifier may be passed into process 700 by another application, and so forth.

The appropriate application to process the enhanced data for the television program is launched, if not already running (act 706). A single application 120 can process the enhanced data for multiple programs, or alternatively different applications 120 can process the enhanced data for different programs. In certain embodiments, an application 120 of FIG. 1 that allows the user to select a program in act 702 also processes the enhanced data. Alternatively, processor 112 of FIG. 1 can execute multiple different applications 120, and different applications may be used to process enhanced data for different television programs or types of television programs. For example, the manner in which enhanced data is processed for a baseball game (e.g., resulting in player statistics being displayed) can be different from the way in which enhanced data is processed for a game show (e.g., resulting in questions being presented to the user and allowing the user to input answers in order to play along with the broadcast game show).

The appropriate application to process enhanced data for a television program can be identified in different manners. In certain embodiments, a monitor application is executed by processor 112, and the monitor application is programmed with or otherwise has access to a mapping of which application programs should process the enhanced data for which television programs. Alternatively, an indication of which application program should process the enhanced data for a particular television program may be embedded as an identifier along with the identifiers for the audio and video components of the program (e.g., analogous to the identifier for the enhanced data discussed above in act 704). Additionally, an identifier for which application program should process the enhanced data for a particular television program my be embedded in a table in the enhanced data itself.

The enhanced data for the television program is obtained (act 708). The enhanced data is obtained using the identifier obtained in act 704. The identifier of the enhanced data is provided to demultiplexer 106 of FIG. 1, which allows demultiplexer 106 to pass the identified enhanced data to processor 112. Demultiplexer 106 can ignore and drop any other enhanced data (e.g., for the other television programs being displayed). In certain embodiments, the enhanced data is obtained from demultiplexer 106 by the application program launched (or already running) in act 706. Alternatively, the enhanced data may be obtained by another application and provided to the application launched (or already running) in act 706.

The locations of the portions of the display in which television programs are being displayed are also identified (act 710). The locations of the different portions are maintained by the client device 102 of FIG. 1 by the applications that instantiated the video objects running on the client device 102. These locations are maintained in a video object as discussed above. The locations of the different portions can be identified using any of a variety of different coordinate systems as discussed above.

The locations of the user interface resulting from processing the received enhanced data are then determined (act 712). This determination in act 712 is based at least in part on the locations of the portions identified in act 710. The exact location determined in act 712 can vary based on the application that is generating the user interface from the received enhanced data, and based on the desires of the designer of the application. However, typically it is desirable for the application to select a location for the user interface that does not interfere with another portion. For example, if the user interface is to be displayed in a blank space next to a portion, then typically it is desirable that the user interface does not overlap another portion. By way of another example, if the user interface is to be superimposed on a particular portion, then typically it is desirable to generate the user interface so that it does not extend beyond that particular portion.

Process 700 is discussed primarily with reference to presenting a user interface for enhanced data for one of multiple television programs being displayed. Alternatively, processor 112 could present user interfaces for the enhanced data for multiple television programs concurrently by repeating process 700 for each of the multiple television programs for which a user interface is to be presented.

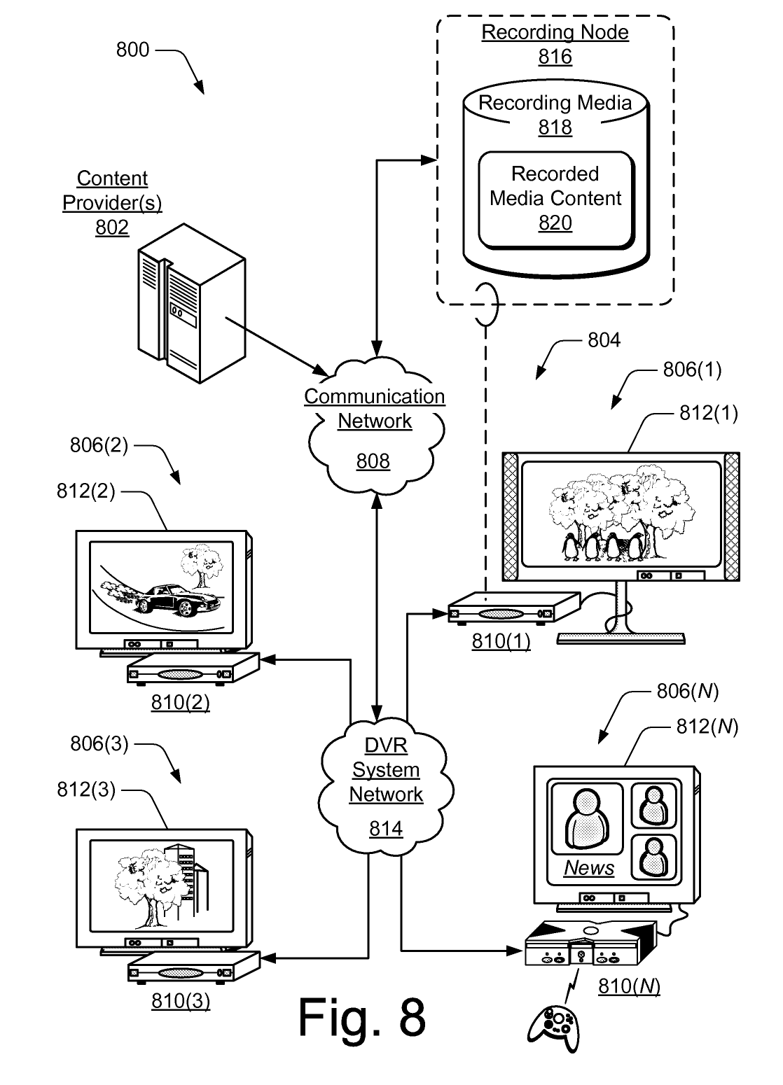

FIG. 8 illustrates an example IP-based television (IPTV) environment 800 in which embodiments of the representing television programs using video objects can be implemented. IPTV environment 800 includes content provider(s) 802 and a multi-DVR system 804 that can include any number of television-based client systems 806(1−N). Multi-DVR system 804 can represent a household viewing system that has several viewing areas, such as different rooms, for viewing television programs. Multi-DVR system 804 is configured for communication with any number of the different content provider(s) 802 via a communication network 808 which, in this example, is an IP-based network. Any of the systems and/or devices can be configured for network access in any number of embodiments and varieties of implementation.

Television-based client systems 806(1−N) of multi-DVR system 804 are representative of DVR nodes in a multi-DVR system. Each of the DVR nodes of multi-DVR system 804 can communicate with each other to act and make decisions on behalf of the other nodes, for the overall common good of multi-DVR system 804, and based on the state of individual nodes and/or based on the state of multi-DVR system 804.

Television-based client system 806(1) includes a television-based client device 810(1) and a display device 812(1), such as any type of television, monitor, LCD, or similar television-based display system that together renders audio, video, and/or image data. Similarly, television-based client systems 806(2−N) each include a respective television-based client device 810(2−N) and a respective display device 812(2−N). Each television-based client device 810 can be implemented in any number of embodiments, such as a television-based set-top box, a digital video recorder (DVR) and playback system, an appliance device, a gaming system such as client device 810(N), and as any other type of client device that may be implemented in a television-based entertainment and information system. Each client device 810 can be implemented as a client device 102 of FIG. 1.

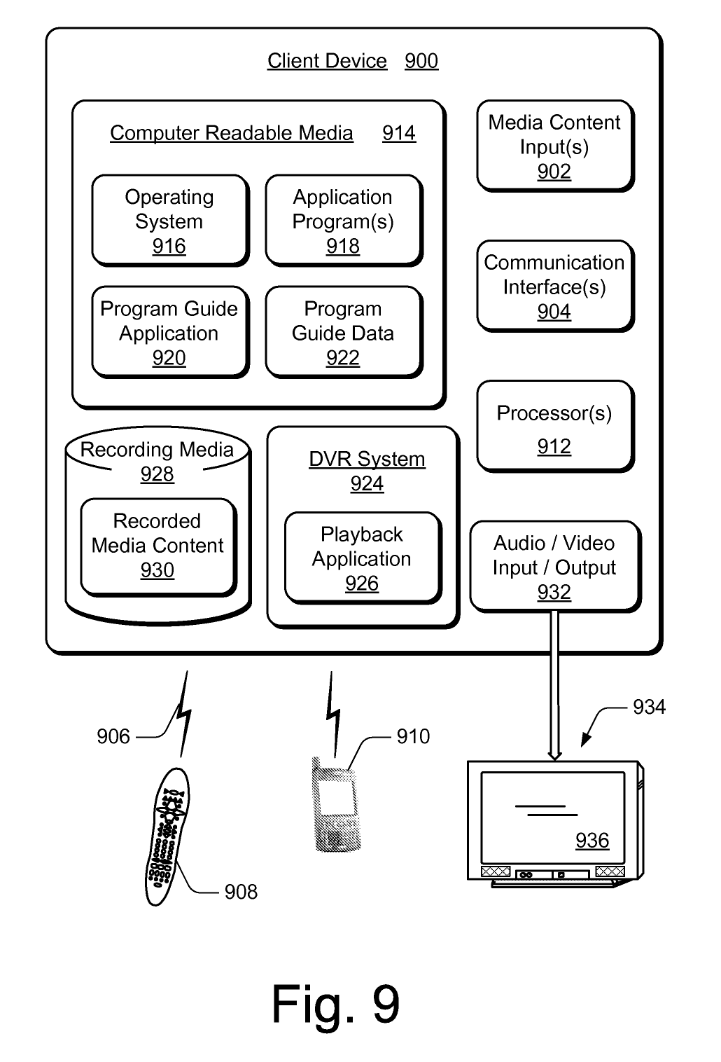

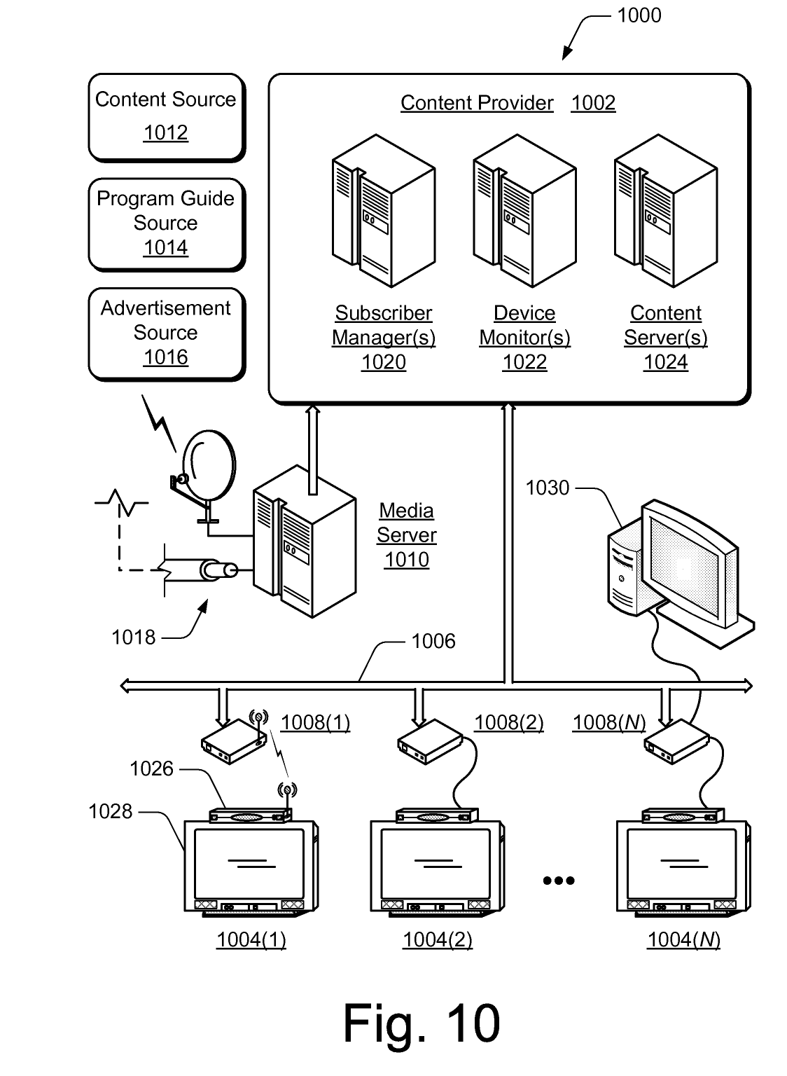

Television-based client devices 810(1−N) of television-based client systems 806(1−N) can be implemented for communication with each other via a DVR system network 814, and may be implemented with any number and combination of differing components as further described below with reference to the example client device shown in FIG. 9. Further, IPTV environment 800 may be implemented with any number and combination of differing components as described below with reference to the example entertainment and information system shown in FIG. 10.

A television-based client system 806 at a node of multi-DVR system 804 can receive programs, associated program content, various forms of media content, program guide data, advertising content, and other types of media content from content server(s) of content provider(s) 802 via communication network 808. Media content can include television programs (or programming) which may be any form of programs, commercials, music, movies, and video on-demand movies. Other media content can include recorded media content, interactive games, network-based applications, and any other similar audio, video, and/or image content. In addition, media content in general may include music streamed from a computing device to a client device, such as a television-based set-top box, and may also include video on-demand media content delivered from a server, a photo slideshow, and any other audio, video, and/or image content received from any type of media content source.

Although the data streams are not shown specifically, the arrowed communication links illustrate various data communication links which include the data streams. Additionally, the arrowed communication links are not intended to be interpreted as a one-way communication link from DVR system network 814 to a client device 810(1), for example. It is contemplated that any one or more of the arrowed communication links can facilitate two-way data communication, such as from communication network 808 to a content provider 802.

Multi-DVR system 804 includes a recording node 816 which includes a recording media 818 to maintain recorded media 820. In an embodiment, any one or more of the television-based client devices 810(1−N) in the multi-DVR system 804 can be implemented as recording node 816 (as shown by the dashed line) which includes recording media 818 to record media content received from a content provider 802. Alternatively (or in addition), a recording node of multi-DVR system 804 can be implemented as a network-based recording node that the multi-DVR system 804 can communicate with via the communication network 808. In another implementation, recording node 816 can be an independent component of multi-DVR system 804.

Recording node 816 can record media content with recording media 818 for any one or more of television-based client devices 810(1−N) of multi-DVR system 804. For example, a television-based client device 810 can initiate a record request to have media content recorded for a scheduled recording or to record and provide a pause buffer for the television-based client device. Recording node 816 can receive the record request and record the media content such that the television-based client device can access and render the recorded media content from the recording node via the DVR system network 814 and/or the communication network 808.

FIG. 9 illustrates various components of an example client device 900 which can be implemented as any form of a computing, electronic, or television-based client device in which embodiments of the representing television programs using video objects can be implemented. For example, client device 900 can be implemented as a television-based client device at a DVR node of multi-DVR system shown in FIG. 8. Client device 900 can also be implemented as a client device 102 of FIG. 1.

Client device 900 includes one or more media content inputs 902 which may include Internet Protocol (IP) inputs over which streams of media content are received via an IP-based network. Device 900 further includes communication interface(s) 904 which can be implemented as any one or more of a serial and/or parallel interface, a wireless interface, any type of network interface, a modem, and as any other type of communication interface. A wireless interface enables client device 900 to receive control input commands 906 and other information from an input device, such as from remote control device 908, a portable computing-based device (such as a cellular phone) 910, or from another infrared (IR), 802.11, Bluetooth, or similar RF input device.

A network interface provides a connection between client device 900 and a communication network by which other electronic and computing devices can communicate data with device 900. Similarly, a serial and/or parallel interface provides for data communication directly between client device 900 and the other electronic or computing devices. A modem facilitates client device 900 communication with other electronic and computing devices via a conventional telephone line, a DSL connection, cable, and/or other type of connection.

Client device 900 also includes one or more processors 912 (e.g., any of microprocessors, controllers, and the like) which process various computer executable instructions to control the operation of device 900, to communicate with other electronic and computing devices, and to implement embodiments of multi-DVR node communication. Client device 900 can be implemented with computer readable media 914, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 914 provides data storage mechanisms to store various information and/or data such as software applications and any other types of information and data related to operational aspects of client device 900. For example, an operating system 916 and/or other application programs 918 can be maintained as software applications with the computer readable media 914 and executed on processor(s) 912 to implement embodiments of multi-DVR node communication.

For example, client device 900 can be implemented to include a program guide application 920 that is implemented to process program guide data 922 and generate program guides for display which enable a viewer to navigate through an onscreen display and locate broadcast programs, recorded programs, video on-demand programs and movies, interactive game selections, network-based applications, and other media access information or content of interest to the viewer.

Client device 900 can also include a DVR system 924 with playback application 926, and recording media 928 to maintain recorded media content 930 which may be any form of on-demand and/or media content such as programs, movies, commercials, music, and similar audio, video, and/or image content that client device 900 receives and/or records. Further, client device 900 may access or receive additional recorded media content that is maintained with a remote data store (not shown), such as from a video-on-demand server, or media content that is maintained at a broadcast center or content provider that distributes the media content to subscriber sites and client devices. The playback application 926 is a video control application that can be implemented to control the playback of media content, the recorded media content 930, and or other video on-demand media content, music, and any other audio, video, and/or image media content which can be rendered and/or displayed for viewing.

Client device 900 also includes an audio and/or video output 932 that provides audio and video to an audio rendering and/or display system 934, or to other devices that process, display, and/or otherwise present audio, video, and image data. Video signals and audio signals can be communicated from device 900 to a display device 936 via an RF (radio frequency) link, S-video link, composite video link, component video link, analog audio connection, or other similar communication link. Alternatively, the audio rendering and/or display system 934 is/are integrated components of the example client device 900.

FIG. 10 illustrates an example entertainment and information system 1000 in which an IP-based television environment can be implemented, and in which embodiments of the representing television programs using video objects can be implemented. System 1000 facilitates the distribution of media content, program guide data, and advertising content to multiple viewers and to multiple viewing systems. System 1000 includes a content provider 1002 and television-based client systems 1004(1−N) each configured for communication via an IP-based network 1006. Each television-based client system 1004(1−N) is an example of the television-based client systems 806(1−N) described with reference to FIG. 8. Each of the television-based client systems 1004(1−N) can receive one or more data streams from content provider 1002 which are then distributed to one or more other television-based client devices at DVR nodes of a multi-DVR system.

Network 1006 can be implemented as a wide area network (e.g., the Internet), an intranet, a Digital Subscriber Line (DSL) network infrastructure, or as a point-to-point coupling infrastructure. Additionally, network 1006 can be implemented using any type of network topology and any network communication protocol, and can be represented or otherwise implemented as a combination of two or more networks. A digital network can include various hardwired and/or wireless links 1008(1−N), routers, gateways, and so on to facilitate communication between content provider 1002 and client systems 1004(1−N). Television-based client systems 1004(1−N) receive media content, program content, program guide data, advertising content, closed captions data, and the like from content server(s) of content provider 1002 via IP-based network 1006.

System 1000 includes a media server 1010 that receives media content from a content source 1012, program guide data from a program guide source 1014, and advertising content from an advertisement source 1016. In an embodiment, media server 1010 represents an acquisition server that receives the audio and video media content from content source 1012, an EPG server that receives the program guide data from program guide source 1014, and/or an advertising management server that receives the advertising content from advertisement source 1016.

Content source 1012, program guide source 1014, and advertisement source 1016 control distribution of the media content, the program guide data, and the advertising content to media server 1010 and/or to other television-based servers. The media content, program guide data, and advertising content is distributed via various transmission media 1018, such as satellite transmission, radio frequency transmission, cable transmission, and/or via any number of other wired or wireless transmission media. In this example, media server 1010 is shown as an independent component of system 1000 that communicates the program content, program guide data, and advertising content to content provider 1002. In an alternate implementation, media server 1010 can be implemented as a component of content provider 1002.

Content provider 1002 is representative of a headend service in a television-based content distribution system, for example, that provides the media content, program guide data, and advertising content to multiple subscribers (e.g., the television-based client systems 1004(1−N)). Content provider 1002 can be implemented as a satellite operator, a network television operator, a cable operator, and the like to control distribution of media content, program and advertising content, such as movies, television programs, commercials, music, and other audio, video, and/or image content to client systems 1004(1−N).

Content provider 1002 includes various components to facilitate media data processing and content distribution, such as a subscriber manager 1020, a device monitor 1022, and a content server 1024. Subscriber manager 1020 manages subscriber data, and device monitor 1022 monitors the client systems 1004(1−N) (e.g., and the subscribers), and maintains monitored client state information.

Although the various managers, servers, and monitors of content provider 1002 (to include media server 1010 in one embodiment) are illustrated and described as distributed, independent components of content provider 1002, any one or more of the managers, servers, and monitors can be implemented together as a multi-functional component of content provider 1002. Additionally, any one or more of the managers, servers, and monitors described with reference to system 1000 can implement features and embodiments of multi-DVR node communication.

Television-based client systems 1004(1−N) can be implemented to include a television-based client device 1026 and a display device 1028 (e.g., a television, LCD, and the like). A television-based client device 1026 of a television-based client system 1004 can be implemented in any number of embodiments, such as a set-top box, a digital video recorder (DVR) and playback system, an appliance device, a gaming system, and as any other type of client device that may be implemented in a television-based entertainment and information system. In an alternate embodiment, client system 1004(N) is implemented with a computing device 1030 as well as a television-based client device 1026. Additionally, any of the television-based client devices 1026 of a television-based client system 1004 can implement features and embodiments of multi-DVR node communication as described herein.

Various modules and techniques may be described herein in the general context of computer-executable instructions, such as applications or program modules, executed by one or more computers or other devices. Generally, applications or program modules include routines, programs, objects, components, data structures, etc. that perform particular tasks or implement particular abstract data types. Typically, the functionality of the applications or program modules may be combined or distributed as desired in various embodiments.

An implementation of these applications, modules, and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Alternatively, all or portions of these modules and techniques may be implemented in hardware or a combination of hardware, software, and/or firmware. For example, one or more application specific integrated circuits (ASICs) or programmable logic devices (PLDs) could be designed or programmed to implement one or more portions of the framework.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for identifying a television program that is concurrently displayed among a plurality of television programs on a common display, the method comprising:
instantiating a video object;
associating the video object with the television program, the video object comprising:
one or more properties identifying the television program and a location on the common display where the television program is being displayed; and
one or more methods to allow the properties of the video object to be controlled.

2. A method as recited in claim 1, wherein the one or more methods includes a method to turn on private data filtering for the television program.

3. A method as recited in claim 1, further comprising:
identifying, based at least in part on the video object, the location indicating where the television program is displayed on the common display; and
using the location to determine where a user interface resulting from processing enhanced data for the television program is to be displayed on the common display.

4. A method as recited in claim 3, wherein using the location comprises determining a location for the user interface that does not overlap a portion of the common display where another television program of the plurality of television programs is being displayed and does not interfere with another user interface of another television program of the plurality of television programs.

5. A method as recited in claim 3, further comprising:
identifying, based at least in part on video objects corresponding to other television programs of the plurality of television programs, additional locations identifying where the other television programs of the plurality of television programs are being displayed on the common display; and
using the additional locations to determine where the user interface is to be displayed on the common display.

6. A method as recited in claim 3, further comprising:
identifying a second television program of the plurality of television programs;
using enhanced data for the television program to generate a user interaction model for the television program;
using enhanced data for the second television program to generate a second user interaction model for the second television program; and
presenting a user interface of the user interaction model and a second user interface of the second user interaction model on the common display concurrently.

7. A method as recited in claim 1, further comprising performing the instantiating and associating in response to a user selection of the television program.

8. A method as recited in claim 1, the one or more properties including:
coordinates indicating where the television program is displayed on the display;
a program identifier;
an enhanced data identifier; and
an additional identifier for each of one or more additional components of the television program.

9. A method as recited in claim 1, the one or more methods including:
a first method that can be invoked to turn on or off audio playback for the television program;
a second method that can be invoked to turn on or off video display for the television program;
a third method that can be invoked to turn on or off private data filtering for the television program; and
a fourth method that can be invoked to change the location and dimensions of a portion of the common display where the television program is being displayed.

10. One or more computer readable media having stored thereon a plurality of instructions that, when executed by one or more processors, causes the one or more processors to:
instantiate and access a data structure corresponding to a television program, the data structure comprising:
a first data field including data representing a location on a display where the television program is displayed;
a second data field including data representing a program identifier of the television program; and
a third data field including data representing one or more packet identifiers (PIDs), each of the one or more packet identifiers being associated with a different component of the television program.

11. One or more computer-readable media as recited in claim 10, the data structure further comprising a method that can be invoked to turn on or off private data filtering for the television program.

12. One or more computer-readable media as recited in claim 10, wherein the different components of the television program include an audio component, a video component, and an enhanced data component.

13. One or more computer-readable media as recited in claim 10, wherein the plurality of instructions further causes the one or more processors to use the data structure to determine where a user interface associated with the television program is to be displayed on the display.

14. One or more computer-readable media as recited in claim 13, wherein to use the data structure is further to:
identify, from one or more additional data structures, additional locations on the display where one or more other television programs are being displayed on the display; and
use the additional locations to determine where the user interface is to be displayed on the display.

15. One or more computer-readable media as recited in claim 13, wherein to use the data structure is to determine a location of the user interface on the display that superimposes the user interface on the location on the display where the television program is displayed.

16. One or more computer-readable media as recited in claim 13, wherein to use the data structure is to determine a location of the user interface on the display that is in a blank space by the location on the display where the television program is displayed.

17. A system comprising:
a demultiplexer; and
a processor, coupled to the demultiplexer, to:
receive, from the demultiplexer, enhanced data for one television program of a plurality of television programs being displayed simultaneously on a display;
obtain, from a video object corresponding to the one television program, coordinates indicating where the one television program is being displayed on the display; and
use the coordinates to determine where a user interface resulting from processing the enhanced data is to be displayed on the display.

18. A system as recited in claim 17, the video object further including a method that can be invoked to turn on or off private data filtering for the television program.

19. A system as recited in claim 17, wherein the monitor is further to:
repeat the reception, obtaining, and use for one or more additional television programs of the plurality of television programs so that user interfaces for the one television program and the one or more additional television programs are displayed simultaneously on the display.

20. A system as recited in claim 17, the video object further including:
a program identifier of the one television program;
an enhanced data identifier of the enhanced data for the television program;
an identifier of video data for the television program; and
an identifier of audio data for the television program.
